(19) United States
(12) Patent Application Publication
(10) Pub. No.: US 2019/0300258 A1
(43) Pub. Date: Oct. 3, 2019

(54) Pre-Measured Baking System

(71) Applicant: Elisa McGowan, Hackettstown, NJ (US)

(72) Inventor: Elisa McGowan, Hackettstown, NJ (US)

(21) Appl. No.: 16/365,746

(22) Filed: Mar. 27, 2019

Related U.S. Application Data
(60) Provisional application No. 62/648,583, filed on Mar. 27, 2018.

(51) Int. Cl. B65D 77/04; B65D 65/16; B65D 65/04; B65D 77/38; A21D 10/00; G01F 19/00

(52) U.S. Cl. CPC B65D 77/0413; B65D 65/16; B65D 65/04; B65D 2203/02; A21D 10/005; G01F 19/00; B65D 77/38

(57) ABSTRACT

Systems are provided for facilitating food preparation. One such system includes one or more flexible packaging containers, wherein the one or more flexible packaging containers include a removable portion configured to enable a user to access the one or more premeasured materials, and one or more premeasured materials housed within the one or more flexible packaging containers.

### CLAIM OF PRIORITY

This application is a United States non-provisional application and claims priority to U.S. Provisional Patent Application No. 62/648,583, filed Mar. 27, 2018, incorporated herein by reference in its entirety.

### FIELD OF THE EMBODIMENTS

This invention relates to measurement systems and methods and, in particular, to systems and methods for aiding users with preparing foods using premeasured ingredients.

### BACKGROUND OF THE EMBODIMENTS

Food preparation is not always a simple process. When preparing a meal from scratch, multiple ingredients are often required in order to prepare a meal. Many times, specific quantities of each of the multiple ingredients are needed. This requires the food preparer to separately measure each of the ingredients. This requires both the time required for measuring the ingredients and the containers needed to store the ingredients until the ingredients are needed.

Furthermore, since many recipes require small amounts of certain ingredients, food preparers often must purchase large quantities of ingredients of which they will only use a small percentage.

For at least these reasons, a system and method of efficiently organizing, preparing, and purchasing ingredients is needed.

Examples of related art are described below:

U.S. Pat. No. 4,219,136 generally describes an apparatus for measuring and dispensing a predetermined quantity of particulate material from a container. The apparatus includes a measuring and dispensing assembly permanently secured at least in part within a container, particularly a disposable container such as a box of dry laundry detergent. The measuring and dispensing assembly defines a chamber within the container which may be opened to permit a predetermined measured quantity of the contents of the container to enter thereinto, and then closed to separate the measured quantity from the remaining contents of the container. To permit dispensing of the measured quantity of particulate material from the closed chamber, the assembly further includes a movable member which may be moved to expose a discharge opening in the container which is adjacent the chamber.

U.S. Pat. No. 4,456,625 generally describes ready-to-eat baked goods which contain a substantial portion of non-gelatinized starch, and are shelf stable for up to one year. They are prepared from a flour containing base-batter mix, water, and at least 5% by weight of the product of an edible, liquid polyhydric alcohol. The water activity level of the baked good is equal to or less than 0.85, the ratio of total water to edible liquid, polyhydric alcohol is equal to or less than 4.8 and the ratio of flour to edible, liquid polyhydric alcohol is equal to or less than 5.6.

U.S. Pat. No. 4,511,585 generally describes ready-to-eat baked goods which are of high quality and are shelf stable for up to one year. They are prepared from a flour containing base-batter mix, water, and at least 5% by weight of the product of an edible, liquid polyhydric alcohol. The water activity level of the baked good is equal to or less than 0.85, the ratio of total water to edible liquid, polyhydric alcohol is equal to or less than 4.8 and the ratio of starch to edible, liquid polyhydric alcohol is equal to or less than 3.95.

U.S. Patent Publication No. 2005/0029297 generally describes an improved measuring cup with volumetric indicia disposed on the inside of the cup that are viewable from above the cup, while the cup is disposed on a horizontal countertop or work surface. The horizontally upward facing volume indicia eliminate the need to raise the measuring cup to eye level to check the amount of material that has been added to the cup or the need to stoop down and view a side of the cup while the cup is disposed on a horizontal countertop or work surface. An improved handle is also disclosed which makes the cup more stable and less prone to being tipped over and spilled during use on a horizontal work surface.

U.S. Patent Publication No. 2005/0249842 generally describes a quantity of packed brown sugar is disposed in a wrapper which has a plurality of markings on it that correspond to respective volumes of the packed brown sugar. A user is thus able to separate a desired volume of packed brown sugar from the remainder of the quantity of packed brown sugar by cutting the quantity of packed brown sugar at a location indicated by the marking on the wrapper that corresponds to the desired volume of packed brown sugar. In another embodiment, a package includes a plurality of individual containers each containing a pre-measured volume of a single baking ingredient, which pre-measured volume is greater than or equal to one-quarter cup and less than or equal to one cup.

U.S. Patent Publication No. 2009/0286212 generally describes a method and a system for monitoring or controlling and recording a nutritional intake of a subject comprising providing a plurality of different types of foods packaged to contain a predetermined and substantially uniform content of at least one nutritional component; and monitoring or controlling the number of food packages consumed during a predetermined time period. There is also provided a food unit and an assembly of food units for use. In addition, there is provided measuring devices for measuring at least one nutritional component of a food.

U.S. Patent Publication No. 2015/0056334 generally describes baking kit systems and methods, and in particular, baking kit teaching systems and methods. In some examples, a baking kit system includes: a plurality of discretely packaged ingredients in packets configured to be mixed together into a baking mixture, the packets including lower concentration ingredient packets and higher concentration ingredient packets (being respectively of lower and higher concentrations in the baking mixture); a container for retaining the ingredient packets; and a set of instructions providing steps for combining and baking the contents of the ingredient packets. In some further examples, the packets each include an indicium and the set of instructions provides steps for combing the contents of the ingredient packets according to the indicia.

U.S. Patent Publication No. 2016/0192790 generally describes a new range of ready to use home baking products, measured and proportioned, for selection of the required ingredients for the type of cake required and bake. The general idea is that home bakers, without any special baking experience, knowledge or commercial baking background can bake professional tasting cake. The range contains unique concepts which are embodied in the kiosk and associated displays, which include pour and bake batter, dry cake mixes, Danish pastry dough, filling, toppings, icing, fondant and all the other typical ingredients necessary needed and involved in home cake baking, similar to the range of fresh baked commercial available goods. One stop shopping is provided in a kiosk, where not only are all the ingredients available but where the home baker can interface with a baking company's logo and computer display and vending of products for all the various information one may need.

None of the art described above addresses all of the issues that the present invention does.

### SUMMARY OF THE EMBODIMENTS

According to an aspect of the present invention, a system for facilitating food preparation is provided. The system includes one or more flexible packaging containers, wherein the one or more flexible packaging containers include a removable portion configured to enable a user to access the one or more premeasured materials, and one or more premeasured materials housed within the one or more flexible packaging containers.

It is an object of the present invention to provide the system for facilitating food preparation, wherein each of the one or more flexible packaging containers include a narrow end and a wide end.

It is an object of the present invention to provide the system for facilitating food preparation, wherein the one or more flexible packaging containers being configured to rest in an upright position.

It is an object of the present invention to provide the system for facilitating food preparation, wherein the one or more flexible packaging containers are resting in the upright position when the wide end is on a surface and the narrow end is above the wide end.

It is an object of the present invention to provide the system for facilitating food preparation, wherein the removable portion is removable via a perforated edge in the one or more flexible packaging containers.

It is an object of the present invention to provide the system for facilitating food preparation, wherein the one or more flexible packaging containers include plastic.

It is an object of the present invention to provide the system for facilitating food preparation, wherein the one or more flexible packaging containers are transparent.

It is an object of the present invention to provide the system for facilitating food preparation, wherein each of the one or more flexible packaging containers are cone-shaped.

It is an object of the present invention to provide the system for facilitating food preparation, wherein each of the one or more flexible packaging containers are approximately the same dimensions.

It is an object of the present invention to provide the system for facilitating food preparation, wherein the one or more premeasured materials are food ingredients.

It is an object of the present invention to provide the system for facilitating food preparation, wherein the system further includes an outer packaging container configured to house the one or more flexible packaging containers.

It is an object of the present invention to provide the system for facilitating food preparation, wherein the outer packaging container includes heavyweight paperboard.

It is an object of the present invention to provide the system for facilitating food preparation, wherein the outer packaging container is resealable.

It is an object of the present invention to provide the system for facilitating food preparation, wherein the one or more flexible packaging containers are rectangular in shape.

It is an object of the present invention to provide the system for facilitating food preparation, wherein each of the flexible packaging containers includes a label indicated a volume of any contents of each of the flexible packaging containers.

It is an object of the present invention to provide the system for facilitating food preparation, wherein the flexible packaging containers a material selected from the group consisting of: cellophane; and paper.

It is an object of the present invention to provide the system for facilitating food preparation, wherein the flexible packaging containers include an internal moisture barrier.

### BRIEF DESCRIPTION OF THE DRAWINGS

FIG. 1 shows two cone-shaped bags of the present system, according to an embodiment of the present invention.

FIG. 2 shows two cone-shaped bags of the present system in an upright position, according to an embodiment of the present invention.

FIG. 3 shows three cone-shaped bags of the present system, according to an embodiment of the present invention.

FIG. 4 shows three cone-shaped bags of the present system in an upright position, according to an embodiment of the present invention.

FIGS. 5A-5B show perspective views of outer packaging for holding pre-measured packaging containers, according to an embodiment of the present invention.

FIGS. 6A-6D show pre-measured packaging containers of various quantities, according to an embodiment of the present invention.

### DESCRIPTION OF THE PREFERRED EMBODIMENTS

The preferred embodiments of the present invention will now be described with reference to the drawings. Identical elements in the various figures are identified with the same reference numerals.

Reference will now be made in detail to each embodiment of the present invention. Such embodiments are provided by way of explanation of the present invention, which is not intended to be limited thereto. In fact, those of ordinary skill in the art may appreciate upon reading the present specification and viewing the present drawings that various modifications and variations can be made thereto.

According to an embodiment, the present system includes one or more pre-measured packaging cups. According to an embodiment, the one or more pre-measured packaging cups include one or more cellophane, cone-shaped bags. It is noted, however, that the one or more pre-measured packaging cups may include one or more rigid structures. According to an embodiment, the bags may, instead of, or in addition to, cellophane, include any other suitable material, while maintaining the spirit of the present invention. For example, the bags may include paper packaging, may include a moisture barrier, may include plastic, and/or may include any other suitable material. According to an embodiment, the bags have dimensions of approximately 10 inches by 5 inches. It is noted, however, that any other suitable dimensions may also be used, while maintaining the spirit of the present invention.

According to an embodiment, one or more materials may be filled in the wide end of the bags. The one or more materials may include, e.g., flour, sugars, and/or any other suitable materials. According to an embodiment, once the bags are filled with the one or more materials, the bags are then sealed.

According to an embodiment, each of the bags may include a removable upper portion. According to an embodiment, the removable upper portion may be a lid, an upper portion connected with a perforation, and/or any other suitable removable upper portion.

According to an embodiment, each bag is labeled. According to an embodiment, the label includes the contents of the bag, including what materials are in the bag and/or the amount of each material in the bag. For example, the label may indicate 1 cup, ½ cup, ⅓ cup, ¼ cup.

According to an embodiment, upon use, a consumer places each of the one or more bags on a surface, with the wide side down and the narrow (or tip) side up. This creates a flat bottom as the material inside the bags falls to the bottom, creating a free standing package. According to an embodiment, the bags may include one or more perforation lines.

According to an embodiment, the one or more perforation lines are marked on package at a location where the consumer would cut to pour the material out of the bags, easily and mess free, into a mixing bowl.

According to an embodiment, the system may be manufactured in multiple ways.

According to an embodiment, only pre-measured 1 cup packages in a box and a variety pack consisting of all different size cups.

The present system may, according to some embodiments, be marked for certain occasions. For example, the packaged food may be designated for a particular holiday. Manufacturers may stamp holiday markings on one or more of the bags. These markings may be, e.g., snowflakes, snowmen, poinsettias, gingerbread men, and/or any other relevant markings.

According to an embodiment, the bags may include prepackaged materials. These materials may be for certain recipes, occasions, etc. For example, pre-measured packaging of different types of flours, sugars, etc., may be used. This pre-packaging of materials cuts down on both the time and mess associated with preparing foods.

According to an embodiment, before purchase, every product has its own unique appeal and performance. This new packaging concept is an improvement upon the existing technologies and methods and creates competitive advantages over other products as it differentiates itself from competing companies.

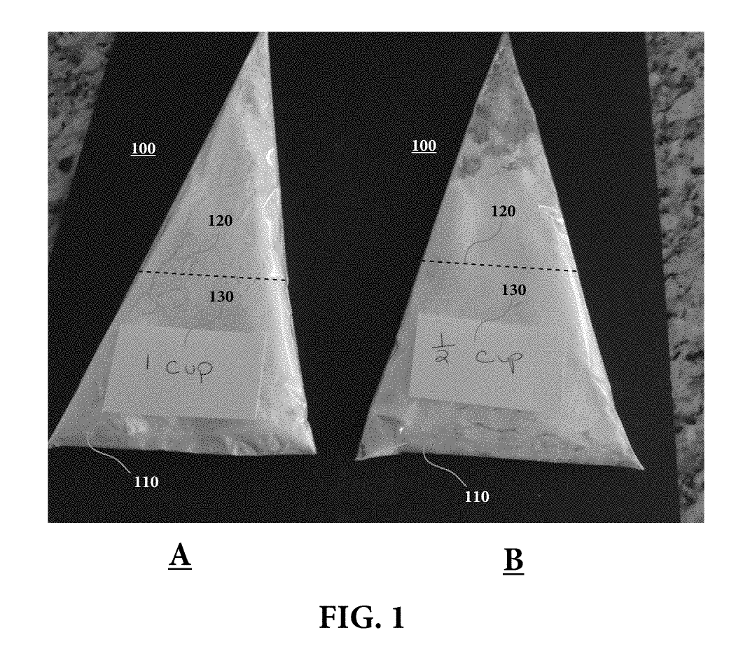

Referring now to FIG. 1, two cone-shaped bags 100 of the present system are illustratively depicted, in accordance with an embodiment of the present invention.

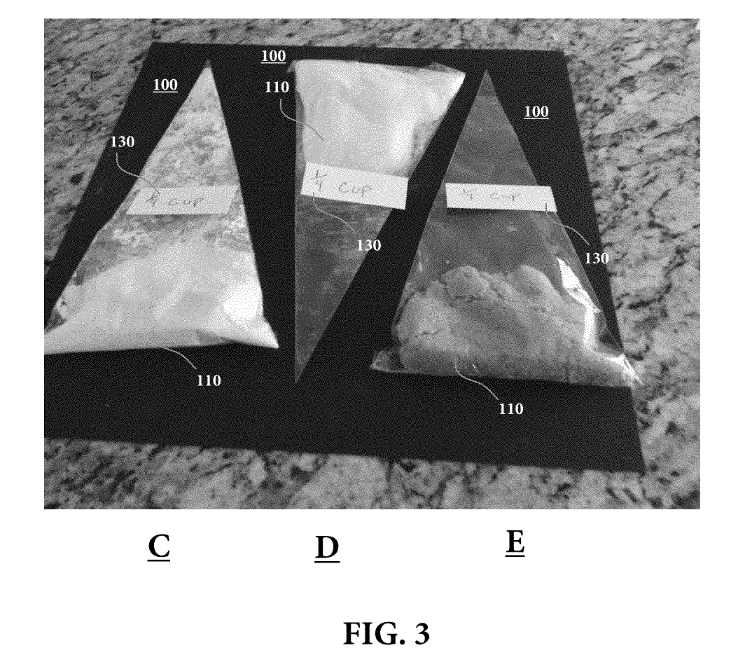

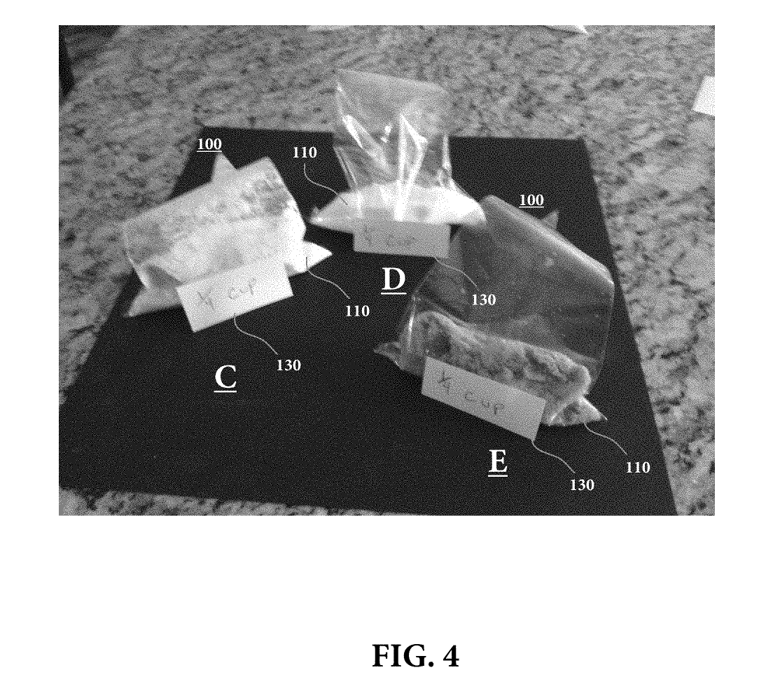

According to the embodiment shown in FIG. 1, bag A is filled with 1 cup of a material 110 and bag B is filled with ½ cup of a material 110. According to an embodiment, the material 110 is flour. It is noted, however, that other materials 110, such as, e.g., brown sugar, white sugar, corn starch, baking powder, baking soda, and/or any other suitable material, may also be used, while maintaining the spirit of the present invention. It is further noted other suitable measurements of material 110, such as ¼ cup (such as in bag C, bag D, and bag E in FIGS. 3-4), ⅛ cup, 1/16 cup, 1 tablespoon, 1 teaspoon, and/or any other suitable measurement may be used, while maintaining the spirit of the present invention. According to an embodiment, each bag 100 is labeled. According to an embodiment, the label 130 includes the contents of the bag 100, including what materials 110 are in the bag 100 and/or the amount of each material 110 in the bag 100.

According to an embodiment, bag A and bag B are filled with the same material 110. According to an embodiment, the material 110 in bag A is different from the material in bag B. According to an embodiment, bag A and bag B are the same size. According to an embodiment, bag A and bag B are different in size.

According to an embodiment, the bags 100 may include one or more perforation lines 120. According to an embodiment, the one or more perforation lines 120 are marked on the packages 100 at a location where the consumer would cut to pour the material 110 out of the packages 100, easily and mess free, into a mixing bowl.

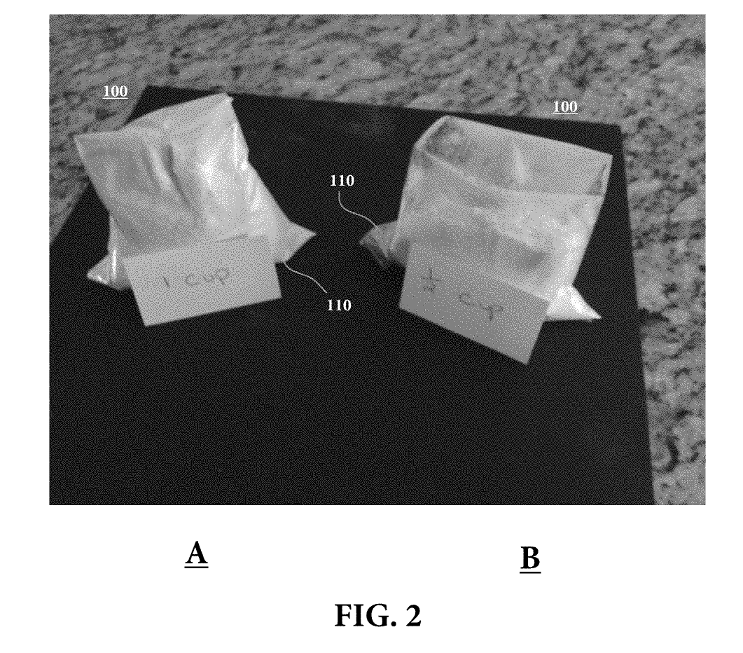

Referring now to FIG. 2, the two cone-shaped bags 100 of the present system standing upright are illustratively depicted, in accordance with an embodiment of the present invention.

According to an embodiment, one end of each of the bags 100 is wider than the other end of each of the bags 100. According to an embodiment, bag A and bag B are designed such that each bag 100 is capable of standing upright, with the wider portion against a surface. According to an embodiment, the bags 100 are cone-shaped. It is noted, however, that any suitable shape configured to stand upright may be used, while maintaining the spirit of the present invention.

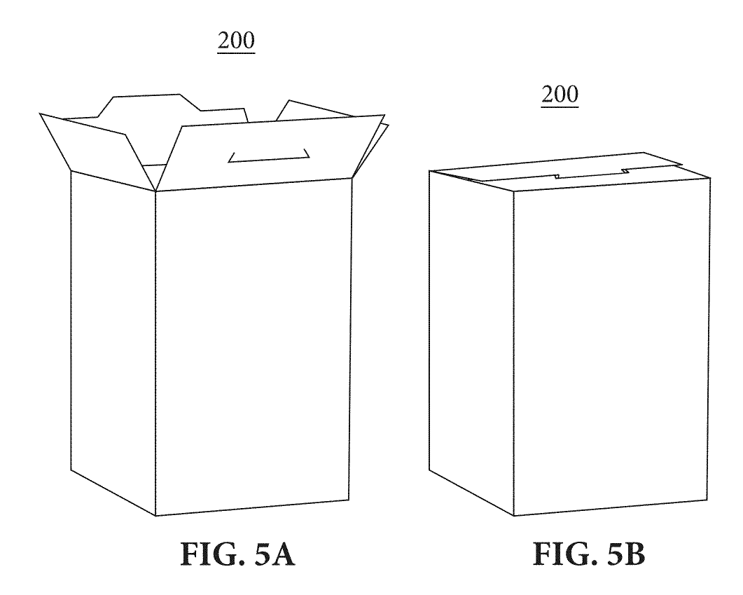

According to an embodiment, pre-measured packaging containers may be housed within an outer packaging 200 (shown open in FIG. 5A and closed in FIG. 5B). According to an embodiment, the outer packaging 200 may include durable and/or strong material such as, e.g., heavyweight paperboard and/or any other suitable material. According to an embodiment, the outer packaging 200 may be constructed to include properties such as, e.g., withstanding crushing, stackability, economically viable, eco-friendly, resealable, and/or any other suitable beneficial properties.

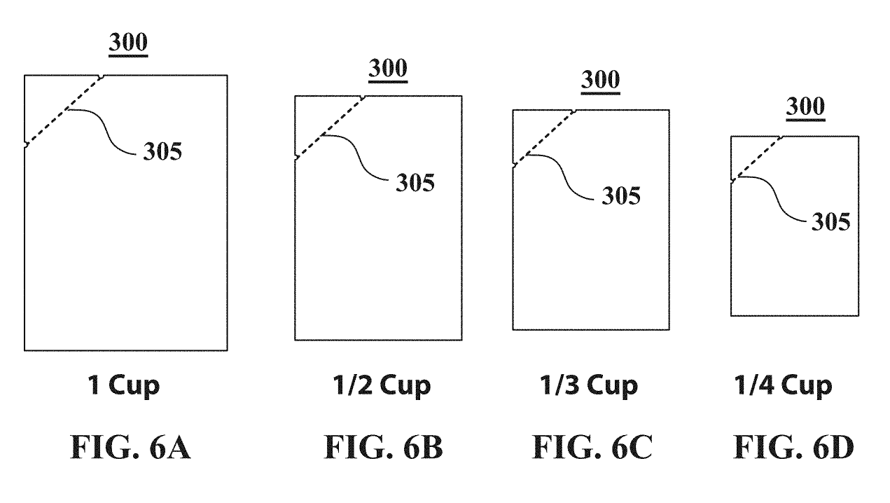

According to an embodiment, the present invention may incorporate rectangular pre-measured containers 300 for housing ingredients. The containers 300 may be packaged in varying quantities such as, e.g., 1 cup (FIG. 6A), ½ cup (FIG. 6B), ⅓ cup (FIG. 6C), ¼ cup (FIG. 6D)), and/or any other suitable quantities. According to an embodiment, the containers 300 include a perforated section 305 configured to aid the user in opening the containers 300.

When introducing elements of the present disclosure or the embodiment(s) thereof, the articles “a,” “an,” and “the” are intended to mean that there are one or more of the elements. Similarly, the adjective “another,” when used to introduce an element, is intended to mean one or more elements. The terms “including” and “having” are intended to be inclusive such that there may be additional elements other than the listed elements.

Although this invention has been described with a certain degree of particularity, it is to be understood that the present disclosure has been made only by way of illustration and that numerous changes in the details of construction and arrangement of parts may be resorted to without departing from the spirit and the scope of the invention.

What is claimed is:

1. A system for facilitating food preparation, comprising:
one or more flexible packaging containers,
wherein the one or more flexible packaging containers include a removable portion configured to enable a user to access the one or more premeasured materials; and
one or more premeasured materials housed within the one or more flexible packaging containers.

2. The system as recited in claim 1, wherein each of the one or more flexible packaging containers include a narrow end and a wide end.

3. The system as recited in claim 1, wherein the one or more flexible packaging containers being configured to rest in an upright position.

4. The system as recited in claim 3, wherein the one or more flexible packaging containers are resting in the upright position when the wide end is on a surface and the narrow end is above the wide end.

5. The system as recited in claim 4, wherein the removable portion is removable via a perforated edge in the one or more flexible packaging containers.

6. The system as recited in claim 1, wherein the one or more flexible packaging containers include plastic.

7. The system as recited in claim 1, wherein the one or more flexible packaging containers are transparent.

8. The system as recited in claim 1, wherein each of the one or more flexible packaging containers are cone-shaped.

9. The system as recited in claim 1, wherein each of the one or more flexible packaging containers are approximately the same dimensions.

10. The system as recited in claim 1, wherein the one or more premeasured materials are food ingredients.

11. The system as recited in claim 1, further comprising an outer packaging container configured to house the one or more flexible packaging containers.

12. The system as recited in claim 11, wherein the outer packaging container includes heavyweight paperboard.

13. The system as recited in claim 11, wherein the outer packaging container is resealable.

14. The system as recited in claim 1, wherein the one or more flexible packaging containers are rectangular in shape.

15. The system as recited in claim 1, wherein each of the flexible packaging containers includes a label indicated a volume of any contents of each of the flexible packaging containers.

16. The system as recited in claim 1, wherein the flexible packaging containers a material selected from the group consisting of: cellophane; and paper.

17. The system as recited in claim 1, wherein the flexible packaging containers include an internal moisture barrier.
